(19) United States
(12) Patent Application Publication
(10) Pub. No.: US 2013/0233617 A1
(43) Pub. Date: Sep. 12, 2013

(54) CABLE END TERMINATION

(71) Applicant: SIEMENS AKTIENGESELLSCHAFT, Muenchen (DE)

(72) Inventors: ENGELBERT ENGELS, KOELN (DE); ACHIM LANGENS, LOHMAR (DE); TIM SCHNITZLER, KREUZAU (DE)

(73) Assignee: SIEMENS AKTIENGESELLSCHAFT, MUENCHEN (DE)

(21) Appl. No.: 13/790,366

(22) Filed: Mar. 8, 2013

(30) Foreign Application Priority Data
Mar. 8, 2012 (DE) 10 2012 203 712.8

(51) Int. Cl. H01R 3/00

(52) U.S. Cl. CPC H01R 3/00
USPC 174/74 A

(57) ABSTRACT

A cable end termination has an outer insulator that is supported on a cable-end carrying flange at one end and carries an outdoor connection at the other end. An opening containing an insulating body for inserting a cable end is formed in the carrying flange. The novel cable end termination has a simple construction and is easy to install, because the insulating body of the cable end termination is a controlled high-voltage bushing with a central plug contact that is accessible from the outside.

### CROSS-REFERENCE TO RELATED APPLICATION

This application claims the priority, under 35 U.S.C. §119, of German patent application DE 10 2012 203 712.8, filed Mar. 8, 2012; the prior application is herewith incorporated by reference in its entirety.

### BACKGROUND OF THE INVENTION

### Field of the Invention

The invention relates to a cable end termination having an outer insulator which is supported on a cable-end carrying flange at one end and carries an outdoor connection at the other end, wherein an opening containing an insulating body for inserting a cable end is present in the carrying flange.

In a prior known cable end termination of this kind (lecture notes from Prof. Volker Hinrichsen, “High-Voltage Technology”, Winter Semester '10/'11+Summer Semester '11, page 22, from the Technical University of Darmstadt), the insulating body is a cylindrical hollow cylinder. In the installed state, the cable without a casing is routed into the interior of the outer insulator through the hollow space in the hollow cylinder. In this case, potential control is also performed by means of a ground electrode with an insulating cone which has been pushed on. The construction of the prior known cable end termination overall is relatively complicated and additionally has to be performed on site. In this case, the ground electrode which has been pushed on and the insulating cone initially have to be removed from the prefabricated cable end; these parts have to be joined again after the cable end has been passed through the insulating body of the carrying flange.

### SUMMARY OF THE INVENTION

It is accordingly an object of the invention to provide a cable end terminal which overcomes the above-mentioned disadvantages of the heretofore-known devices and methods of this general type and which provides for a cable end termination that has a simple construction and that is easy to install.

With the foregoing and other objects in view there is provided, in accordance with the invention, a cable end termination, comprising:
a cable-end carrying flange having an opening formed therein;
an outer insulator having a first end supported at the cable-end carrying flange and a second end carrying an outdoor connection; and
an insulating body for insertion of a cable end disposed in the opening formed in the carrying flange, the insulating body being a controlled high-voltage bushing with a central plug contact.

In other words, the object is achieved, in accordance with the invention, by providing the insulating body in a novel cable end termination with a controlled high-voltage bushing that has a central plug contact which is accessible from the outside.

A significant advantage of the cable end termination according to the invention is that a prefabricated cable end can be readily introduced into the controlled high-voltage bushing; the cable end termination itself does not need to be opened for this purpose. A further advantage is that the conductive inserts in the controlled high-voltage bushing provide good field control at the outdoor end.

This is true, in particular, when the cable end termination according to the invention has, at least at its end which is averted from the outer insulator, an inner conical recess, which is open in the direction of said end, for receiving the correspondingly shaped cable end.

In an advantageous embodiment of the cable end termination according to the invention, the recess in the high-voltage bushing is shaped in accordance with a cable end having a ground electrode pushed onto it and having an insulating cone. Optimum field control can be achieved as a result.

Various insulating materials, for example cast resin, can be used as the material for insulating the high-voltage bushing of the cable end termination according to the invention. However, it is considered to be particularly advantageous when the insulation of the high-voltage bushing is composed of resin-impregnated paper because this means particularly fine field control can be achieved by control inserts which are particularly closely spaced apart from one another.

Other features which are considered as characteristic for the invention are set forth in the appended claims.

Although the invention is illustrated and described herein as embodied in a cable end termination, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 shows a side view of an exemplary embodiment of the cable end termination according to the invention; and

FIG. 2 shows an enlarged detail from FIG. 1.

### DETAILED DESCRIPTION OF THE INVENTION

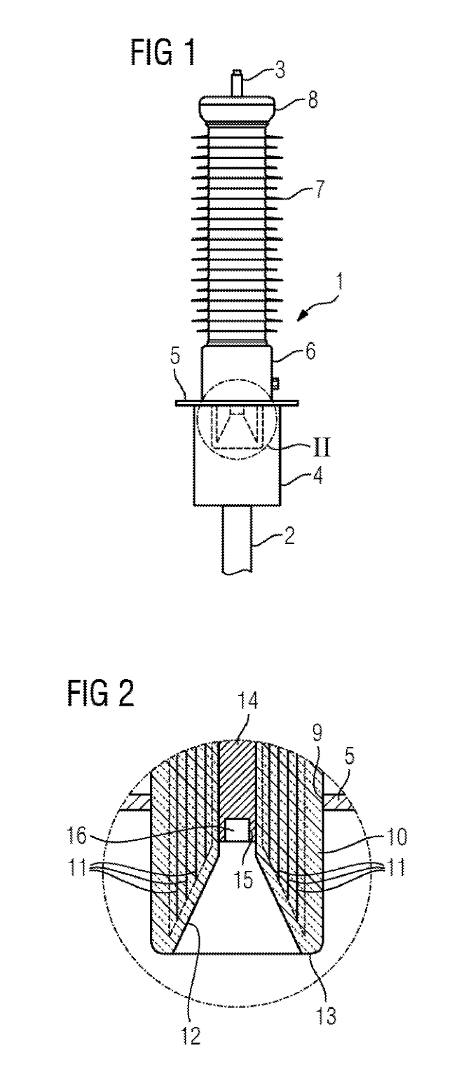

Referring now to the figures of the drawing in detail and first, particularly, to FIG. 1 thereof, there is shown a cable end termination 1 which provides an electrical transition from a cable, by way of its cable end 2, to an outdoor high-voltage connection 3. As can also be seen in FIG. 1, the cable end termination 1 has a protective covering 4 which is terminated at the top by a carrying flange 5. An outer insulator 7, which is in the form of a screening insulator, is supported on the carrying flange 5 by way of an annular housing part 6. The outer insulator 7 has the outdoor high-voltage connection 3 of a high-voltage connection fitting 8 at the top.

Referring now to the detail illustrated in FIG. 2, a controlled high-voltage bushing 10, which is provided with conductive inserts 11, is arranged in an opening 9 formed in the carrying flange 5. The high-voltage bushing 10 is formed with an inner conical opening 12 which opens at that end 13 of the high-voltage bushing 10 which is at the bottom in FIG. 2. A cylindrical conductor 14 is provided at the base of the inner conical recess 12. The cylindrical conductor 14 extends upward in the direction of the high-voltage connection mount 8 and is designed as a central plug contact 16 at its end 15 which is at the bottom in FIG. 2.

If the protective housing 4 is detached from the carrying flange 5, the central plug contact 16 is freely accessible from the outside, and therefore a cable 2, which is correspondingly prefabricated at its end, is readily pushed into the conical recess 12 in the high-voltage bushing 10 by way of a ground electrode and an insulating cone and can be plugged into the central plug contact 16 by way of its internal conductor.

The insulation of the high-voltage bushing 10 can be composed of different materials, for example encapsulation compound such as cast resin. In the illustrated exemplary embodiment, resin-impregnated paper is preferred for the insulation of the high-voltage bushing 10 because a high-voltage bushing with an insulation of this kind can be provided with a relatively large number of conductive inserts 11 in a relatively simple manner.

1. A cable end termination, comprising:
a cable-end carrying flange;
an outer insulator having a first end supported at said cable-end carrying flange and a second end carrying an outdoor connection;
said carrying flange having an opening formed therein;
an insulating body for insertion of a cable end disposed in said opening of said carrying flange, said insulating body being a controlled high-voltage bushing with a central plug contact.

2. The cable end termination according to claim 1, wherein said high-voltage bushing is formed, at least at an end thereof that is averted from said outer insulator, with an inner conical recess that is open in a direction towards the said end, for receiving a correspondingly shaped cable end.

3. The cable end termination according to claim 2, wherein said conical recess in said high-voltage bushing is shaped in accordance with the cable end having a ground electrode pushed thereonto and having an insulating cone.

4. The cable end termination according to claim 1, wherein said high-voltage bushing has an insulation composed of resin-impregnated paper.
